(19) United States
(12) Patent Application Publication
(10) Pub. No.: US 2026/0230623 A1
(43) Pub. Date: Aug. 6, 2026

(54) METHOD AND APPARATUS FOR ENCODING/DECODING IMAGE AND RECORDING MEDIUM FOR STORING BITSTREAM

(71) Applicants: Hyundai Motor Company, Seoul (KR); Kia Corporation, Seoul (KR)

(72) Inventors: Jungah CHOI, Seoul (KR); Jin HEO, Yongin-si Gyeonggi-do (KR); Seung Wook PARK, Yongin-si Gyeonggi-do (KR)

(21) Appl. No.: 19/147,784

(22) PCT Filed: Feb. 29, 2024
(86) PCT No.: PCT/KR2024/002673

§ 371 Date: Jul. 14, 2025

(30) Foreign Application Priority Data
Mar. 2, 2023 (KR) 10-2023-0027593
Feb. 29, 2024 (KR) 10-2024-0029787

(51) Int. Cl. H04N 19/136; H04N 19/176; H04N 19/70

(52) U.S. Cl. CPC H04N 19/136; H04N 19/176; H04N 19/70

(57) ABSTRACT

A method and apparatus for encoding/decoding an image, a recording medium for storing a bitstream, and a transmission method are provided. The method for decoding an image comprises determining whether a current block is in intra template matching mode, determining a template shape of the current block among a plurality of template shape candidates, searching for a reference template based on a current template according to the template shape, and generating a prediction block of the current block based on the reference template.

### TECHNICAL FIELD

The prevent invention relates to a method and apparatus for encoding/decoding an image and a recording medium for storing a bitstream. Particularly, the present invention relates to a method and apparatus for encoding/decoding an image based on a method of using a plurality of prediction shape candidates in intra template matching and a recording medium for storing a bitstream.

### BACKGROUND ART

Recently, the demand for high resolution and high quality images such as ultra high definition (UHD) images increases in various application fields. As image data becomes higher in resolution and quality, the amount of data increases relatively compared to existing image data. Therefore, when transmitting such image data using existing media such as wired or wireless broadband channels, or when storing it using existing storage media, both transmission and storage costs increase. To solve these problems that occur as image data becomes higher in resolution and quality, a high-efficiency image encoding/decoding technique is required for images with higher resolution and image quality.

In video encoding and decoding method and apparatus, intra template matching is an intra prediction mode (intra template matching prediction, intra TMP) that searches for a most similar block to a current block (e.g., coding tree block, coding unit, coding block, prediction unit, prediction block, transform unit, transform block, etc.) by performing template matching in a reconstructed area within a current picture and uses the searched block as a prediction block for the current block.

The existing intra template matching method generates a prediction block for a current block by using only one block that is most similar. Accordingly, when an intra template matching method is used, coding performance may be limited.

### DISCLOSURE

### Technical Problem

An object of the present invention is to provide a method and apparatus for encoding/decoding an image with improved encoding/decoding efficiency.

Another object of the present invention is to provide a recording medium for storing a bitstream that is generated by generated by a method or apparatus for decoding an image according to the present invention.

Another object of the present invention is to provide a method for performing multi-candidate intra template matching prediction.

### Technical Solution

A method for decoding an image according to an embodiment of the present invention may comprise determining whether a current block is in intra template matching mode, determining a template shape of the current block among a plurality of template shape candidates, searching for a reference template based on a current template according to the template shape, and generating a prediction block of the current block based on the reference template.

In the method for decoding the image, whether the current block is in intra template matching mode may be determined based on information that is signaled through a bitstream, and the information that is signaled through the bitstream may include information indicating whether the intra template matching mode of the current block uses the plurality of template shape candidates.

In the method for decoding the image, the prediction block of the current block may be generated through a weighted sum of matching blocks adjacent to different reference templates corresponding to the current template.

In the method for decoding the image, a weight used for the weighted sum of the matching blocks may be determined based on a cost value of each of the different reference templates.

In the method for decoding the image, the weight used for the weighted sum of the matching blocks may be determined based on a look-up table corresponding to the cost value of each of the different reference templates.

In the method for decoding the image, when a cost value of at least one of the different reference templates is greater than a threshold value, the prediction block of the current block may be generated through the weighted sum of the matching blocks that are different each other, and the threshold value may be set based on a cost value of the plurality of template shape candidates.

In the method for decoding the image, the current template may be determined among the plurality of template shape candidates, based on the information that is signaled through the bitstream.

In the method for decoding the image, the current template may be determined based on a shape of a reference template with highest similarity to the current template among the plurality of template shape candidates.

A method for encoding an image according to an embodiment of the present invention may comprise determining whether a current block is in intra template matching mode, determining a template shape of the current block among a plurality of template shape candidates, searching for a reference template based on a current template according to the template shape, and generating a prediction block of the current block based on the reference template.

A non-transitory computer-readable recording medium for storing a bitstream, which is generated by a method for encoding an image according to an embodiment of the present invention, may comprise determining whether a current block is in intra template matching mode, determining a template shape of the current block among a plurality of template shape candidates, searching for a reference template based on a current template according to the template shape, and generating a prediction block of the current block based on the reference template.

A method for transmitting a bitstream generated by a method for encoding an image according to an embodiment of the present invention may comprise determining whether a current block is in intra template matching mode, determining a template shape of the current block among a plurality of template shape candidates, searching for a reference template based on a current template according to the template shape, and generating a prediction block of the current block based on the reference template.

The features briefly summarized above with respect to the present disclosure are provided as an example only to explain the detailed description and are not construed to limit the scope of the present disclosure.

### Advantageous Effects

According to the present invention, it is possible to provide a method and apparatus for encoding/decoding an image with improved encoding/decoding efficiency.

Also, according to the present invention, it is possible to improve prediction efficiency and coding efficiency by using a plurality of template shape candidates to predict a current block that is in intra template matching mode.

Also, according to the present invention, it is possible to reduce computational complexity by calculating a weight for weighted summation of different templates without, while not using floating point operation.

Effects obtainable from the present disclosure are not limited to the above-mentioned effects, and other effects that are not mentioned will be clearly understood by those skilled in the art from the following description.

### DESCRIPTION OF DRAWINGS

FIG. 1 is a block diagram showing a configuration of an encoding apparatus according to an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 is a view for describing intra template matching according to an embodiment of the present invention.

FIG. 5 is a view for describing a plurality of template shape candidates used for intra template matching prediction according to an embodiment of the present invention.

FIG. 6 is a view for describing a method for predicting a current block by using different templates in intra template matching prediction according to an embodiment of the present invention.

FIG. 7 is a flowchart showing a method for decoding an image according to an embodiment of the present invention.

FIG. 8 is a view for illustrating a content streaming system to which an embodiment according to the present invention is applicable.

### MODE FOR INVENTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term is and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

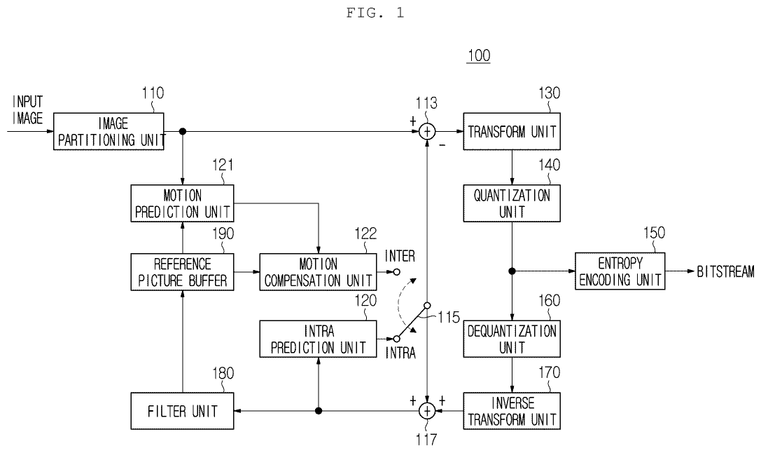

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT BT VER), a horizontal binary split mode (SPLIT BT HOR), a vertical ternary split mode (SPLIT TT VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

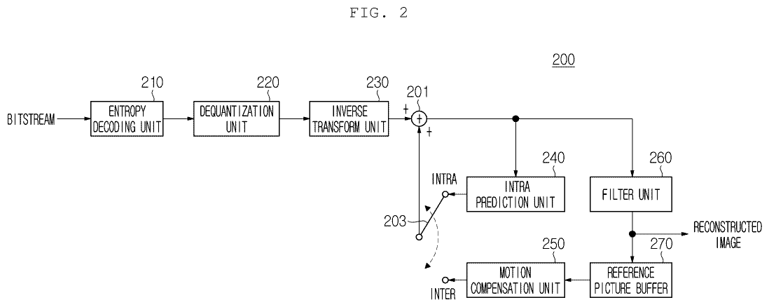

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

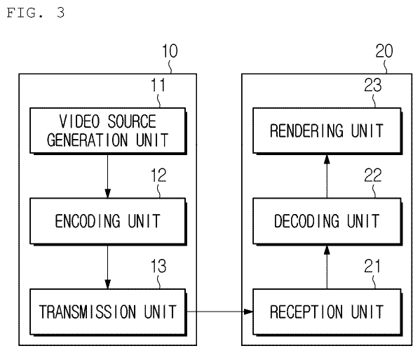

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

The present specification describes embodiments of a method for determining a reference template of a current block that is in intra template matching mode. Herein, the reference template may be a template corresponding to a current template of the current block.

According to an embodiment of the present invention, a current template of a current block may be determined according to a template shape that is determined among a plurality of template shape candidates. In addition, a reference template may be searched for based on a determined current template.

Before a method for determining a reference template of a current block, which is in intra template matching mode, is described, intra template matching will be described.

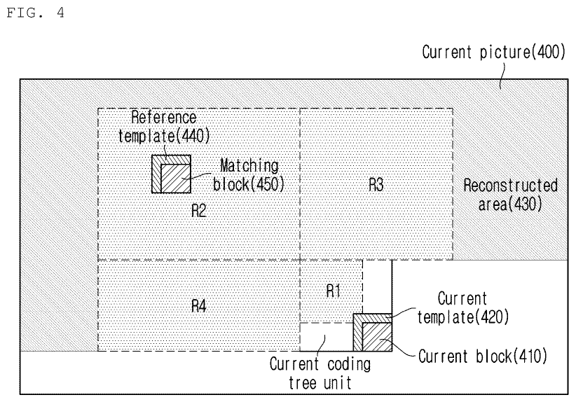

Herein, referring to FIG. 4, a method for deriving an intra prediction mode for a current block, which is encoded/decoded by intra template matching according to an embodiment of the present invention, will be described.

In the present invention, intra template matching is an intra prediction method that searches for a most similar block to a current block by performing template matching in a reconstructed area within a current picture and derives the searched block as a prediction block for the current block. An intra prediction method, which derives a prediction block for a current block based on a search block, may be defined as intra template matching prediction (intra TMP).

FIG. 4 is a view for describing intra template matching prediction according to an embodiment of the present invention.

Referring to FIG. 4, based on a current block 410, intra template matching prediction may determine an optimal prediction block for the current block in a reconstructed area 430 within a current picture 400. Specifically, in intra template matching prediction, a set of adjacent reference pixels surrounding the current coding block 410 may be defined as a current template 420. In addition, a matching block 450 may be determined by searching for a reference template 440 with highest similarity to the current template 420 through template matching-based search performed within the reconstructed area 430 based on the current template 420. Herein, the matching block 450 may be used as a prediction block for the current block 410.

Meanwhile, template matching-based search may be performed in predefined regions R1, R2, R3 and R4 in the reconstructed area 430, and the search may be performed in the order of R1, R2, R3 and R4.

A residual signal for the current block 410, which is in intra template matching mode, may be generated by using the current block 410 and the matching block 450.

When intra template matching prediction is performed, the reference template 440, which has highest similarity to the F-shaped current template 420 surrounding the current block, is searched for in a search region, and a block adjacent to the reference template 440 is determined as a matching block.

The present invention proposes a method for considering not a single template shape but a plurality of template shape candidates, when template matching-based search is performed in intra template matching prediction. When template matching-based search is performed by considering a plurality of template shape candidates, coding performance may be improved over the related art that uses only one F-shaped template. Intra template matching using a plurality of template shape candidates may be referred to as multi-candidate intra template matching.

According to an embodiment of the present invention, information indicating whether multi-candidate intra template matching is used may be signaled.

Information indicating whether multi-candidate intra template matching is used may be signaled at least one high level among video parameter set (VPS), sequence parameter set (SPS), picture parameter set (PPS), picture header, and slice header. Information indicating whether multi-candidate intra template matching is used may be signaled independently of information indicating whether intra template matching is used. Alternatively, information indicating whether multi-candidate intra template matching is used may be signaled in subordination to information indicating whether intra template matching is used.

Table 1 shows information indicating whether multi-candidate intra template matching is used, which is signaled through SPS.

TABLE 1

| | Descriptor |
|---|---|
| seq_parameter_set_rbsp( ) { | |
| (...) | |
| sps_multiple_intra_tmp_enabled_flag | u(1) |
| (...) | |
| } | |

In Table 1, the flag indicating whether multi-candidate intra template matching is used (sps_multiple_intra_tmp_enabled_flag) may be signaled in SPS. In addition, the flag indicating whether multi-candidate intra template matching is used may be signaled independently of information indicating whether intra template matching is used.

According to an embodiment of the present invention, information indicating whether intra template matching is used and whether multi-candidate intra template matching is used may be signaled.

Table 2 shows information indicating whether intra template matching is used and information indicating whether multi-candidate intra template matching is used, which are signaled through SPS.

TABLE 2

| | Descriptor |
|---|---|
| seq parameter set rbsp( ) { | |
| (...) | |
| sps_intra_tmp_enabled_flag | u(1) |
| if(sps_intra_tmp_enabled_flag) | |
| sps_multiple_intra_tmp_enabled_flag | u(1) |
| (...) | |
| } | |

In Table 2, the flag indicating whether intra template matching is used (sps_intra_tmp_enabled_flag) may be signaled in SPS. In addition, if the value of the flag indicating whether intra template matching is not 0, the flag indicating whether multi-candidate intra template matching is used (sps_multiple_intra_tmp_enabled_flag) may be signaled in SPS. That is, the flag indicating whether multi-candidate intra template matching is used may be signaled in subordination to the flag indicating whether intra template matching is used.

According to an embodiment of the present invention, information indicating whether multi-candidate intra template matching is used may be signaled in a plurality of levels

Table 3 shows information indicating whether multi-candidate intra template matching is used, which is signaled through SPS and picture header.

TABLE 3

| | Descriptor |
|---|---|
| seq_parameter_set_rbsp( ) { | |
| (...) | |
| sps_multiple_intra_tmp_enabled_flag | u(1) |
| if(sps_multiple_intra_tmp_enabled_flag) | |
| sps_multiple_intra_tmp_control_present_in_ph_flag | u(1) |
| (...) | |
| } | |

| | Descriptor |
|---|---|
| picture_header_structure( ) { | |
| (...) | |
| if(sps_multiple_intra_tmp_control_present_in_ph_flag) | |
| ph_multiple_intra_tmp_disabled_flag | u(1) |
| (...) | |
| } | |

In Table 3, the flag indicating whether multi-candidate intra template matching is used (sps_multiple_intra_tmp_enabled_flag) may be signaled in SPS. In addition, if the value of the flag indicating whether multi-candidate intra template matching is not 0, the flag indicating whether control information for multi-candidate intra template matching is present (sps_multiple_intra_tmp_control_present_in_ph_flag) may be signaled in SPS. The flag indicating whether control information for multi-candidate intra template matching is present may indicate whether control information regarding multi-candidate intra template matching is present in picture header.

If the value of the flag indicating whether control information for multi-candidate intra template matching is present is not 0, the flag indicating that multi-candidate intra template matching prediction is not used (ph_multiple_intra_tmp_disabled_flag) may be signaled in picture header. Accordingly, multi-candidate intra template matching may be applied in picture unit, not entire image.

According to an embodiment of the present invention, information indicating whether multi-candidate intra template matching is used may be signaled in a plurality of layers.

Table 4 shows information indicating whether multi-candidate intra template matching prediction is used, which is signaled through SPS and picture header.

TABLE 4

| | Descriptor |
|---|---|
| seq_parameter_set_rbsp( ) { | |
| (...) | |
| sps_multiple_intra_tmp_enabled_flag | u(1) |
| if(sps_multiple_intra_tmp_enabled_flag) | |
| sps_multiple_intra_tmp_control_present_in_sh_flag | u(1) |
| (...) | |
| } | |
| | Descriptor |
| slice_header_structure( ) { | |
| (...) | |
| if(sps_multiple_intra_tmp_control_present_in_sh_flag) | |
| sh_multiple_intra_tmp_disabled_flag | u(1) |
| (...) | |
| } | |

In Table 4, the flag indicating whether multi-candidate intra template matching prediction is used (sps_multiple_intra_tmp_enabled_flag) may be signaled in SPS. In addition, if the value of the flag indicating whether multi-candidate intra template matching prediction is not 0, the flag indicating whether control information for multi-candidate intra template matching is present (sps_multiple_intra_tmp_control_present_in_sh_flag) may be signaled in SPS. The flag indicating whether control information for multi-candidate intra template matching is present may indicate whether control information regarding multi-candidate intra template matching is present in slice header.

If the value of the flag indicating whether control information for multi-candidate intra template matching is present is not 0, the flag indicating that multi-candidate intra template matching prediction is not used (sh_multiple_intra_tmp_disabled_flag) may be signaled in slice header. Accordingly, multi-candidate intra template matching may be applied in slice unit, not entire image.

A plurality of candidates used in multi-candidate intra template matching prediction may be described as follows.

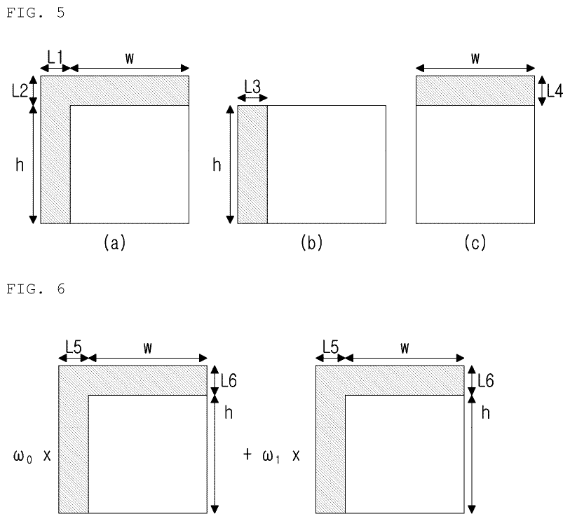

FIG. 5 is a view for describing a plurality of template shape candidates used for intra template matching prediction according to an embodiment of the present invention.

Referring to FIG. 5, to perform multi-candidate intra template matching prediction, a plurality of template shape candidates with different shapes may be used. Among a plurality of template shape candidates with different shapes, a reference template with high similarity to a current template may be used to generate a prediction block for a current block.

Herein, as shown in FIG. 5(a), a template shape candidate may include left and top neighbor samples of the block. The template shape candidate including the left and top neighbor samples of the block may be referred to as [symbol] -shaped template. A size of the [symbol] -shaped template may be expressed by (w×L2)+(L1×h)+(L1×L2). Here, w and h may represent the width and height of the block, and the values of L1 and L2 may be any positive number.

Alternatively, as shown in FIG. 5(b), a template shape candidate may include left neighbor sample of the block. The template shape candidate including the left neighbor sample of the block may be referred to as left template. A size of the left template may be expressed by L3×h. Here, h may represent the height of the block, and the value of L3 may be any positive number.

Alternatively, as shown in FIG. 5(c), a template shape candidate may include top neighbor sample of the block. The template shape candidate including the top neighbor sample of the block may be referred to as top template. A size of the top template may be expressed by w×L4. Here, w may represent the width of the block, and the value of L4 may be any positive number.

According to the embodiment of FIG. 5, the [symbol] -shaped template, the left template and the top template may be used to search for a reference template that is most similar to the current template. Among template shape candidates with any shapes, a template shape candidate with highest similarity to the current template may be used to search for a reference template that is most similar to the current template. Similarity between the current template and a reference template may be evaluated based on a sum of absolute differences (SAD), a mean squared error (MSE), a sum of squared differences (SSD), a sum of absolute transformed differences (SATD), and the like.

However, apart from the examples illustrated in FIG. 5, neighbor samples with various shapes around a block, which are predefined in an encoder and a decoder, may be used. A shape of a template is not limited to the description of the present invention.

In multi-candidate intra template matching prediction, different reference templates with high similarity to a current template may be used to generate a prediction block for a current block.

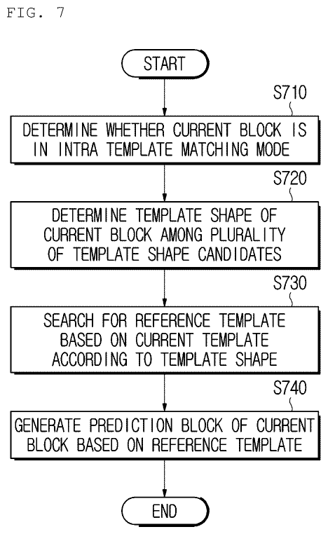

FIG. 6 is a view for describing a method for predicting a current block by using different templates in intra template matching prediction according to an embodiment of the present invention.

Referring to FIG. 6, different reference templates with high similarity to a current template may be used to generate a prediction block for a current block. Herein, a reference template may be a [symbol] -shaped template, and the size of the [symbol] -shaped template may be expressed by (w×L6)+(L5×h)+(L5×L6). Here, w and h may represent the width and height of the current block, and the values of L5 and L6 may be any positive number.

To perform intra template matching prediction, two reference templates with highest similarity to a current template may be determined in a predefined reconstructed area. According to an embodiment, two reference templates may both be a [symbol] -shaped template. According to another embodiment, two reference templates may be templates that are different from each other in shape. For example, two reference templates may be a [symbol] -shaped template and a left template respectively, or may be a [symbol] -shaped template and a top template respectively, or may be a left template and a top template respectively. According to another embodiment, two reference templates may be two reference templates with any shape that is predefined in an encoder and a decoder. Herein, similarity between a current template and a reference template may be evaluated based on at least one method among SAD, MSE, SSD, and SATD.

In addition, matching blocks adjacent to two reference templates may be linearly combined by using different weights w0 and w1. Accordingly, a prediction block of a current block may be generated by using linearly combined matching blocks.

When a current block is predicted, different reference templates, which are not a i-shaped template, may be used. That [symbol] is, a current block may be predicted by using different reference templates that have any shape predefined in an encoder and a decoder.

A prediction block of a current block, which is generated by combining matching blocks that are adjacent to different reference templates, may be expressed as follows.

$${P}_{( x , y )} = {w}_{0} * {P}_{0 ( x , y )} + {w}_{1} * {P}_{1 ( x , y )} \qquad [ Formula 1 ]$$

Here, P_{(x,y)} indicates a prediction block of a current block, P_{0(x,y)} and P_{1(x,y)} indicate matching blocks that are adjacent to different reference templates, and w0 and w1 indicate weights that are applied to respective matching blocks. w0 and w1, which are applied to respective matching blocks, may be calculated as follows.

$${w}_{0} = \frac{{cost}_{1}}{{cost}_{0} + {cost}_{1}} , {w}_{1} = \frac{{cost}_{0}}{{cost}_{0} + {cost}_{1}} \qquad [ Formula 2 ]$$

Here, cost₀ and cost₁ indicate a cost value of a different reference template.

Alternatively, weights w0 and w1, which are applied to respective matching blocks, may be calculated by using a look-up table (LUT). By using a LUT, approximate values of weights w0 and w1 may be derived only through multiplication, addition and shift operation of integers, instead of using floating point operation.

Table 5 shows a pseudo-code for deriving weights applied to different matching blocks by using a look-up table of a convolutional cross-component model (CCCM).

TABLE 5
blend_sum_weight = 6;
sum_weight = 1 << blend_sum_weight
DivSigTable[16] = { 0, 7, 6, 5 ,5, 4, 4, 3, 3, 2, 2, 1, 1, 1, 1, 0 }
x = Floor( Log2( Gx ) )
normDiff=( ( Gx<<4 ) >> x ) & 15
x +=( 3 + ( normDiff != 0 ) ? 1 : 0 )
iRatio = (Gy* ( DivSigTable[ normDiff ] | 8 ) + ( 1<<( x−1 ) )) >> x
w0 = iRatio
w1 = sum weight − iRatio

In the above-described embodiment, when a current block is predicted, a prediction block of the current block is generated by calculating a weighted sum of matching blocks that are derived from two reference templates. However, when a current block is predicted, a prediction block of the current block may be generated by calculating a weighted sum of matching blocks that are derived from N reference templates. Herein, N may be an integer that is equal to or greater than 2. N reference templates used for weighted summation may consist of a [symbol] -shaped template, a left template, a top template, or a template with any shape that is predefined in an encoder and a decoder.

When a current block is predicted, if a cost value of all or some of N reference templates used for weighted summation is similar to a cost value of a plurality of template shape candidates, weighted summation of matching blocks derived from N reference templates may not be meaningful. Accordingly, weighted summation of matching blocks derived from N reference templates may not be considered.

Herein, cost values of a reference template and each of a plurality of template shape candidates may be evaluated based on at least one method among SAD, MSE, SSD, and SATD.

Specifically, if a cost value of all or some of N reference templates used for weighted summation is smaller than a threshold value, weighted summation of matching blocks derived from N reference templates may not be considered a candidate.

Herein, the threshold value may be expressed by the following formulas.

$$Th = \frac{{cost}_{1} + {cost}_{2} + ⋯ + {cost}_{M}}{M} + offset \qquad [ Formula 3 ]$$

$$Th = min ( {cost}_{1} , {cost}_{2} , … , {cost}_{M} ) + offset \qquad [ Formula 4 ]$$

$$Th = max ( {cost}_{1} , {cost}_{2} , … , {cost}_{M} ) + offset \qquad [ Formula 5 ]$$

$$Th = mean ( {cost}_{1} , {cost}_{2} , … , {cost}_{M} ) + offset \qquad [ Formula 6 ]$$

Here, cost₁, cost₂, . . . , cost_{M} may indicate a cost value of each of M template shape candidates. In addition, offset is a value for correction and may be 0, any positive number, or any negative number.

That is, a threshold value may be determined by using a mean value, a minimum value, a maximum value or a median value of cost values of M template shape candidates.

According to an embodiment of the present invention, an encoder may determine a most similar reference template to a current template among template candidates including M template shape candidates with different shapes and a weighted-summated template based on N templates. The encoder may generate a prediction block of a current block by using the determined reference template. In addition, the encoder may signal information on the template used for generating the prediction block of the current block to a decoder.

When the information on the template used for generating the prediction block of the current block is signaled to the decoder, the information on the template may be signaled in a block unit such that computational complexity of the decoder may be reduced.

Table 6 shows information for signaling information on a used template between two template candidates.

TABLE 6

| Template | Codeword |
|---|---|
| Candidate 1 | 0 |
| Candidate 2 | 1 |

For example, if a [symbol] -shaped template and a weighted-summated template are template candidates, the [symbol] -shaped template may be designated as Candidate 1 and assigned a codeword of 0, and the weighted-summated template may be designated as Candidate 2 and assigned a codeword of 1.

Table 7 shows information for signaling information on a used template among three template candidates.

TABLE 7

| Template | Codeword |
|---|---|
| Candidate 1 | 0 |
| Candidate 2 | 10 |
| Candidate 3 | 11 |

If three or more template candidates are used, a truncated binary code may be used to signal a template candidate. Herein, Candidate 1 is assigned a shortest codeword, and the remaining candidates are assigned codewords with same length.

Accordingly, a template candidate, which is used most frequently, may be placed in Candidate 1, and the remaining candidates may be placed in Candidate 2 and Candidate 3. For example, among template candidates including a [symbol] -shaped template, a weighted-summated template and a left template, if the [symbol] -shaped template is used most frequently, Candidate 1 may be the [symbol] -shaped template. On the other hand, if the weighted-summated template is used most frequently, Candidate 1 may be the weighted-summated template.

Table 8 shows information for signaling information on a used template among four template candidates.

TABLE 8

| Template | Codeword |
|---|---|
| Candidate 1 | 0 |
| Candidate 2 | 10 |
| Candidate 3 | 110 |
| Candidate 4 | 111 |

Herein, a template candidate, which is used most frequently, may be placed in Candidate 1, and the remaining candidates may be placed in Candidate 2 to Candidate 4.

According to an embodiment of the present invention, like an encoder, a decoder may perform template matching-based search and determine a most similar template to a template of a current block among M arbitrary templates and a weighted-summated template based on N templates.

That is, the decoder searches for a most similar reference template in a predetermined search area by using a current template consisting of neighbor samples of the current block. Herein, similarity between the current template and the reference template may be evaluated based on at least one method among SAD, MSE, SSD, and SATD. A decoder should perform template search by using a same similarity evaluation method as used by an encoder.

If a decoder performs template matching-based search, complexity may increase as compared to a method of acquiring information on a used template through signaling. However, as the number of bits encoded in encoding process decreases, coding performance may be improved.

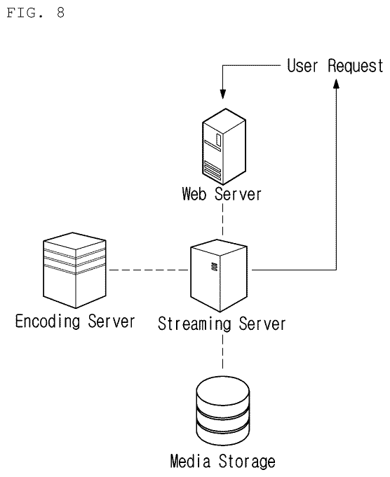

FIG. 7 is a flowchart showing a method for decoding an image according to an embodiment of the present invention. The image decoding method of FIG. 7 may be performed by an image decoding apparatus.

The image decoding apparatus may determine whether a current block is in intra template matching mode (S710).

The image decoding apparatus may determine a template shape of the current block among a plurality of template shape candidates (S720). The plurality of template shape candidates may have different shapes. Embodiments of the plurality of template shape candidates are described in detail in FIG. 5.

The image decoding apparatus may determine a reference template based on a current template according to a template shape (S730).

The image decoding apparatus may generate a prediction block of the current block based on the reference template (S740).

Herein, whether the current block is in intra template matching mode may be determined based on information that is signaled through a bitstream. In addition, the information that is signaled through a bitstream may include information indicating whether an intra template matching mode of the current block uses a plurality of template shape candidates. An embodiment of determining whether the current block is in intra template matching mode based on information signaled through a bitstream is described in detail in Table 1 to Table 4.

Herein, a prediction block of the current block may be generated through weighted sum of matching blocks that are adjacent to different reference templates corresponding to a current template.

Herein, a weight used for the weighted sum of the matching blocks may be determined based on a cost value of each of the different reference templates. The weight used for the weighted sum of the matching blocks may be determined based on a look-up table corresponding to a cost value of each of the different reference templates.

Herein, if a cost value of at least one of the different reference templates is greater than a threshold value, a prediction block of the current block may be generated through weighted sum of different matching blocks. In addition, the threshold value may be set based on cost values of a plurality of template shape candidates. An embodiment of generating through weighted sum of matching blocks adjacent to different reference templates corresponding to a current template is described in detail in FIG. 6.

Herein, the current template may be determined among a plurality of template shape candidates based on information that is signaled through a bitstream. An embodiment of signaling information for determining a current template among a plurality of template shape candidates is described in detail in Table 6 to Table 8.

Herein, a reference template may be determined based on a shape of a reference template with highest similarity to a current template, among a plurality of template shape candidates.

The steps described in FIG. 7 may be performed likewise in an image encoding method. In addition, a bitstream may be generated by an image encoding method including the steps described in FIG. 7. The bitstream may be stored in a non-transitory computer-readable recording medium and also be transmitted (or streamed).

FIG. 8 is a view for illustrating a content streaming system to which an embodiment according to the present invention is applicable.

As illustrated in FIG. 8, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an apparatus for encoding/decoding an image and a recording medium for storing a bitstream.

1. A method for decoding an image, the method comprising:
determining whether a current block is in intra template matching mode;
determining a template shape of the current block among a plurality of template shape candidates;
searching for a reference template based on a current template according to the template shape; and
generating a prediction block of the current block based on the reference template.

2. The method of claim 1, wherein whether the current block is in intra template matching is determined based on information that is signaled through a bitstream, and
wherein the information that is signaled through the bitstream includes information indicating whether the intra template matching mode of the current block uses the plurality of template shape candidates.

3. The method of claim 1, wherein the prediction block of the current block is generated through a weighted sum of matching blocks adjacent to different reference templates corresponding to the current template.

4. The method of claim 3, wherein the weight used for the weighted sum of the matching blocks is determined based on a cost value of each of the different reference templates.

5. The method of claim 4, wherein the weight used for the weighted sum of the matching blocks is determined based on a look-up table corresponding to the cost value of each of the different reference templates.

6. The method of claim 4, wherein when a cost value of at least one of the different reference templates is greater than a threshold value, the prediction block of the current block is generated through the weighted sum of the matching blocks that are different each other, and
wherein the threshold value is set based on a cost value of the plurality of template shape candidates.

7. The method of claim 1, wherein the current template is determined among the plurality of template shape candidates, based on the information that is signaled through the bitstream.

8. The method of claim 1, wherein the current template is determined based on a shape of a reference template with highest similarity to the current template among the plurality of template shape candidates.

9. A method for encoding an image, the method comprising:
determining whether a current block is in intra template matching mode;
determining a template shape of the current block among a plurality of template shape candidates;
searching for a reference template based on a current template according to the template shape; and
generating a prediction block of the current block based on the reference template.

10. A non-transitory computer-readable recording medium for storing a bitstream, which is generated by a method for encoding an image,
wherein the method for encoding an image comprises:
determining whether a current block is in intra template matching mode;
determining a template shape of the current block among a plurality of template shape candidates;
searching for a reference template based on a current template according to the template shape; and
generating a prediction block of the current block based on the reference template.

11. (canceled)
